(19) United States
(12) Patent Application Publication
(10) Pub. No.: US 2021/0319786 A1
(43) Pub. Date: Oct. 14, 2021

(54) MISPRONUNCIATION DETECTION WITH PHONOLOGICAL FEEDBACK

(71) Applicant: OREGON HEALTH & SCIENCE UNIVERSITY, Portland, OR (US)

(72) Inventors: Alexander Kain, Portland, OR (US); Amie Roten, Portland, OR (US)

(21) Appl. No.: 17/225,571

(22) Filed: Apr. 8, 2021

Related U.S. Application Data
(60) Provisional application No. 63/007,347, filed on Apr. 8, 2020.

(51) Int. Cl. G10L 15/187; G10L 15/04; G10L 15/02; G10L 15/197; G10L 15/22; G10L 15/06; G10L 15/16; G06N 3/08

(52) U.S. Cl. CPC G10L 15/187; G10L 15/04; G10L 15/02; G10L 15/197; G10L 2015/025; G10L 15/063; G10L 15/16; G06N 3/08; G10L 2015/225; G10L 15/22

(57) ABSTRACT

Disclosed are embodiments for mapping, with a first trained universal function approximator, the speech representation to predicted phonological feature and phoneme class probabilities; determining expected phonological feature values based on an automatic phonetic segmentation using the expected phoneme sequence and the predicted phoneme class probabilities; and classifying, with a second trained universal function approximator different from the first trained universal function approximator, a combination of the predicted phonological feature probabilities and the expected phonological feature values to thereby detect a mispronunciation present in the sampled speech waveform and facilitate phonological feature feedback associated with the mispronunciation.

### RELATED APPLICATION

This application claims priority benefit of U.S. Provisional Patent Application No. 63/007,347, filed Apr. 8, 2020, which is hereby incorporated by reference.

### FEDERALLY SPONSORED RESEARCH OR DEVELOPMENT

This invention was made with government support under R01 DC013996 awarded by The National Institutes of Health. The government has certain rights in the invention.

### TECHNICAL FIELD

This disclosure relates to a phonological feature-based automatic pronunciation analysis and phonological feedback system.

### BACKGROUND INFORMATION

Speech sound disorders (SSDs) are common among young children, involving deficits in the production of individual or sequences of speech sounds, caused by inadequate planning, control, or coordination of the speech production mechanism, with an estimated 8-10% affected. Children with these disorders experience difficulty in the academic setting. An SSD impacts individuals throughout their lifespan, resulting in subsequent long-term difficulty processing and interpreting language.

SSDs are traditionally diagnosed and treated by trained speech language pathologists (SLPs), with approximately 90% of school-based SLPs reporting having served students with SSDs in 2018. Although many treatment parameters, including format, provider, and timing, may impact outcomes, studies suggest that higher treatment intensity is associated with better outcomes, particularly for children with more severe SSDs. Considering that school-based SLPs' median monthly caseload is 48 students, most receiving an hour of treatment or less per week, face-to-face intervention alone may not be able to provide the appropriate intensity of treatment for all cases.

Given limitations to accessing adequate treatment directly from an SLP, importance of developing effective methods of supplementing human instruction has been appreciated. Since the early 1990s, computer-assisted pronunciation training (CAPT) tools have been investigated as a potential supplement to one-on-one human language instruction, targeting two primary groups: foreign language learners and individuals with speech production disorders. Although both populations present with unique challenges, the goals of an effective CAPT system for both groups largely overlap. Applications targeting children have had limited success, however, in part due to the high variability present in speech of children and in impaired speech. In other words, efficacy of such systems has been limited by a number of factors.

Conventional CAPT systems employ phoneme classifier-based automatic speech recognizers (ASR). In spite of significant recent advances in ASR technology, state-of-the-art phoneme-level recognition accuracy remains at 83.5%. Moreover, the task is particularly difficult when working with speech of children. Subphonemic errors, such as dentalization or lateralization, commonly occur in both typically-developing children's speech as well as that of children having an SSD, posing an additional challenge to phoneme-based CAPT systems. Training a phoneme-based ASR system to recognize and differentiate these fine phonological distinctions (recordable via IPA diacritics) to provide accurate and effective feedback would require a vastly larger dataset than is typically available in order to have adequate representation of the resulting class set.

Early CAPT applications typically used Gaussian mixture model-hidden Markov model (GMM-HMM) based ASR to generate phonetic time-alignments and associated likelihood scores, which were then incorporated into rule-based algorithms to calculate intelligibility scores at speaker or sentence levels. Early likelihood-based scoring techniques resulted in highly variable performance, with sentence-level correlations with human-assigned scores ranging from 0.18 to 0.58. Performance improved significantly when considering speaker-level scores, reaching a correlation of 0.88, exceeding inter-rater correlation for human raters.

Though these scoring methods resulted in acceptable performance on suprasegmental levels, they did not perform adequately in the context of phoneme-level error detection, required to provide detailed, specific feedback to users. To address this, proposed the Goodness of Pronunciation (GOP) score, a likelihood-based paradigm was attempted. The GOP score is based on the ratio between the likelihood of the expected phoneme and that of the most likely phoneme, to which a threshold is applied to determine whether to accept or reject the pronunciation. Early applications of this method showed promise, with subsequent work improving upon the original algorithm by incorporating phoneme-specific decision thresholds, as well as models of both correct and incorrect pronunciations.

As increased computing power became more readily available, more complex methods of acoustic modeling and mispronunciation detection were incorporated into CAPT systems, generally resulting in increased performance. For example, classifier-based methods have been explored for the purpose of phoneme-specific error detection, including linear discriminant analysis and support vector machine methods, the former of which was shown to outperform a traditional GOP-based method. In addition, replacing the traditional GMM-HMM acoustic model with a deep neural network (DNN) based model has shown to result in improved overall CAPT system performance, unsurprising given that “research groups have shown that DNNs can outperform GMMs at acoustic modeling for speech recognition on a variety of datasets.”

Despite these improvements, more recent CAPT attempts remain limited, particularly regarding reliably identifying pronunciation errors from non-native and speech-impaired speakers. Recent work explored using acoustic models that integrate both phoneme class (PC) and phonological feature (PF) information, and incorporating predicted feature posteriors into the mispronunciation detection process, resulting in improved performance over systems based on PCs alone. When comparing performance of a multi-task (PC and PF) DNN-HMM based system to GOP and PC-only classifier systems, the former outperformed both traditional paradigms, providing compelling evidence in support of the inclusion of phonological feature information in CAPT systems.

### SUMMARY OF THE DISCLOSURE

Disclosed are embodiments of a phonological feature-based mispronunciation detection and feedback system and methods. Some embodiments include a multi-target model trained to predict phoneme classes as well as phonological features, and a subsequent multi-target mispronunciation classifier, trained to predict pronunciation scores as well as the most prominent feature error. The first multi-target model maps a speech representation to phoneme classes and phonological features, thereby allowing for detailed, phonological feature-based analysis. A subsequent multi-target mispronunciation model predicts the pronunciation score and most prominent phonological feature error that caused the mispronunciation, from predicted phonological feature probabilities and expected phonological feature values. Statistics of the output can be used to convey to the user information about which phonemes, if any, were mispronounced, and which phonological feature was the leading cause of the mispronunciation.

The disclosed techniques provide an ability to identify specific phonological features for feedback based on a speech representation so as to give user specific corrective feedback, e.g., the phoneme should have been unvoiced. Providing specific phonological feedback is expected to be beneficial in the learning/training process for foreign language learners or individuals, including children (e.g., those aged 4-7), who present with SSD. Thus, disclosed embodiments are useful in a number of applications including (1) at-home articulatory/pronunciation training for foreign language learners or individuals having SSD, (2) automation of clinical screening tests such as the Goldman-Fristoe Test of Articulation, and (3) potentially extended to applications intended to assist with diagnosis of speech disorders. The disclosed techniques may be suitable for integration into an articulatory screening application for clinical use, as well as a pronunciation training system intended for children with an SSD.

Also disclosed is an evaluation of a phonological feature-based mispronunciation detection system on a corpus of adult speech with simulated pronunciation errors, as well as a corpus of speech produced by typically-developing and disordered children aged 4-7. The disclosed mispronunciation detection system achieves high accuracy on an adult mispronunciation corpus, and promising results on the child pronunciation corpus.

Additional aspects and advantages will be apparent from the following detailed description of embodiments, which proceeds with reference to the accompanying drawings.

### BRIEF DESCRIPTION OF THE DRAWINGS

FIG. 1 is a multi-panel figure showing an example of a mispronunciation of the word “thumb” ([θAm]), as “fumb” [fAm]., having, top panel, a spectrogram overlaid with the expected phoneme segmentation, middle panel, expected phonological feature values in solid lines, as well as predicted phonological feature probabilities in broken lines, bottom panel, pronunciation score targets in solid lines, and pronunciation score probabilities in broken lines.

FIG. 2 is a graph showing feedback accuracy results, with each one of five dots on each line indicating a different confidence threshold increment of 0.1 in a range starting from 0.5 and ending at 0.1 (left to right).

FIG. 3 is a block diagram showing an overview of how an annotated flow diagram is arranged across FIGS. 3A, 3B, and 3C.

FIGS. 3A, 3B, and 3C collectively form the annotated flow diagram showing example system inputs, intermediate results, processes, and outputs, as performed by a computer-based system.

FIG. 4 is a block diagram of a computing system, according to one embodiment.

FIG. 5 is a flow diagram in accordance with one embodiment.

### DETAILED DESCRIPTION OF EMBODIMENTS

This disclosure describes embodiments for implementing a pronunciation analysis and phonological feedback system akin to a CAPT system, but with wide applicability. Some embodiments include a convolutional neural network (CNN) that maps acoustic to phonological features and a mispronunciation detection and feedback system. An example experiment is described in which an embodiment is evaluated on a target user-group of children having SSDs. Also described is an embodiment of a mispronunciation detection system that uses phonological feature probabilities as output by a CNN-based acoustic-to-phonological feature mapping system as input to a DNN-based classifier which predicts mispronounced phonemes with 97% accuracy for adults and 77-80% accuracy for children. Using the output of the mispronunciation classifier, along with the predicted and expected phonological feature values, a leading problematic phonological feature is identified with 87-91% accuracy for adults and 67-73% accuracy for children. The disclosed techniques achieve high accuracy on a corpus of adult speech with simulated mispronunciations, and promising results on a corpus of young children, both typically developing and presenting with speech disorders.

Set forth below are additional details describing (1) generation of child and adult corpuses, the latter with synthetic mispronunciations, (2) example implementations of an integrated, phoneme-level mispronunciation detector that also assigns confidence values for the most likely feature error, and (3) example evaluation of mispronunciation detection and feedback performance on speech from children and adults. Finally, example flow charts and diagrams are described.

To prepare a corpus of child speech, speech is collected from multiple children (e.g., 90 kids aged 4-7), of which a first portion (e.g., 47) are typically developing (TD), and a second portion (e.g., 43) are diagnosed with articulation/speech disorder (SD). The diagnosis of a speech sound disorder was based on a licensed, credentialed SLP completing a standardized assessment, and exercising clinical judgment based upon transcribed speech samples and normative data. As co-occurrence of receptive and expressive language disorders is prevalent in children with speech production challenges, all children were screened to ensure ability to complete the tasks required in the study.

Recordings are made of children speaking words from the Goldman-Fristoe Test of Articulation (Sounds-in-Words Section only), including 53 simple words (e.g. “house”), elicited from images with SLP assistance. A second SLP with expertise in speech sound disorders transcribed the speech using the full range of International Phonetic Alphabet (IPA) diacritics to represent distorted productions. This expert also scored whether a phoneme was pronounced correctly or incorrectly. For 33 words, multiple canonical pronunciations were acceptable (e.g., shovel was correctly pronounced [∫AV∂l], [∫AVσl], or [∫AVl]), and thus actual pronunciations were compared relative to the closest canonical pronunciation. Finally, phonetic segmentation was performed by an experienced phonetician.

Approximately 11% A of all phonemes were substitution errors, resulting in a total of 287 unique error pairs. The top two substitutions for both TD and SD groups were [j]→[w], [l]→[w], although these errors occurred twice as often for the SD group than the TD group. The third and fourth most common errors differed between the two groups; they were [₃]→[d₃] and [∫]→[t∫] for the TD group, and [k]→[t] and [s]→[θ] for SD. These error patterns match those previously reported in literature regarding childhood speech development.

To establish baseline performance of the system without the added complexity of children's speech, a mispronunciation corpus is comprised of adult speakers. This corpus is developed using a subset of utterances from the TIMIT corpus, using the phonetically-compact (SX) sentences, resulting in 129 unique sentences, each spoken by five individuals, for 840 total examples. To create a corpus resembling the child corpus (described previously), sentences are split into individual words using the segmentation files provided by the TIMIT developers, excluding stop words, such as “the”, “an”, and “in.” The resulting dataset contains a total of 3883 example words.

The final step in preparing the corpus for use in experiments was to simulate the presence of errors by relabeling segments based on phoneme substitution pairs which occur more than 30 times in the child corpus (14 unique pairs, accounting for 52% of all substitutions). For example, a commonly observed mispronunciation is [s]→[θ]. So, if a [θ] label (the observed phoneme in the error) is encountered, it is replaced by an [s] label (the expected phoneme) to simulate the substitution. About 40% of the segments are relabeled corresponding to an observed phoneme, resulting in approximately 10% of the corpus being relabeled, similar to the percentage of phoneme substitutions in the child corpus.

A goal of an effective CAPT system for children having an SSD is the ability to accurately identify subtle, subphonemic pronunciation differences, represented by diacritics added to base phoneme classes. In the child pronunciation corpus, the diacritic labeling led to a total of 96 classes, most of which were very rare, a difficult task for a standard phoneme-based classifier. This approach maps acoustic input to not only phoneme class labels, but also phonological features, enabling specific, feature-based pronunciation analysis and feedback.

To test the system on adult speech, a multi-target CNN is trained on the standard TIMIT training partition. The CNN architecture includes 4 convolutional and 3 dense layers, batch normalization, parametric ReLU activation functions, and dropout after each layer. Inputs were 32 log filter-bank features over 25 ms frames at a rate of 10 ms, with 12 preceding and 12 following features appended for a total of 265 ms context and 32×25=800 dimensions. A multi-target configuration is selected to map the acoustic features to both PCs and PFs. PC targets were context-independent and single state. Phonemes are split with multiple acoustic states into their constituent parts, e.g., [al]→[a]+[I], and mapped closures and glottal stops to pause, resulting in 48 classes. The multi-label PF targets includes 24 phonological features, coded as 1 (present), 0 (not present), or “NaN” (not a number, to denote “not applicable”), representing: syllabic (syl), sonorant (son), consonantal (cons), continuant (cont), delayed release (delrel), lateral (lat), nasal (nas), strident (strid), voice (voi), spread glottis (sg), constricted glottis (cg), anterior (ant), coronal (cor), distributed (distr), labiodental, labial (lab), high (hi, vowel/consonant, not tone), low (lo, ditto), front, back, round, velaric, tense, and long, as well as a dedicated pause feature. As the TIMIT dataset contains no contrast in three of these (cg, velaric, and long), the final PF set includes 22 features.

A similar architecture may be used on children's speech. For example, to supplement the previously described children's speech corpus for model training, a modified TIMIT database is created by applying a global nonlinear spectral frequency warping, a process similar to vocal tract length normalization, to make the speech sound more childlike, as confirmed by informal analysis-resynthesis listening tests. In an experiment evaluating model performance trained on this data using a variety of warping parameters, including 1.0/unwarped, it was found that a warping factor of 0.8 resulted in the highest accuracy when the model was tested using children's speech. The final system is trained on combined data from the best performing warped TIMIT data and child corpus training sets, and evaluated performance on the child corpus test set. PC and PF are assessed at frame-level classification accuracy (ACC) on each corpus, estimating the most likely class for the PF output by calculating the Euclidean distance between predicted values and all phonemes' expected feature values, converting the distances to probabilities, and normalizing. In addition, the mean absolute error (MAE) is calculated between predicted and expected phonological features, as shown in Table 1.

TABLE 1
Results of Acoustic Modeling Experiments

| | PC | | PF | | |
|---|---|---|---|---|---|
| Corpus | #cls | ACC | #cls | ACC | MAE |
| Adults | 48/35 | 73% | 22 | 68% | 0.09 |
| Children | 103 | 55% | 24 | 45% | 0.15 |

To prepare the model output for further analysis, the speech signal is segmented using forced alignment. A weighted finite state transducer (FST) is constructed from the lattice of PC posterior probabilities and matrix of phoneme state transition probabilities. The FST is constructed with frame-to-phoneme and phoneme-to-word (pronunciation) FSTs. To accept single words, some FSTs align a single pronunciation from the set of possible canonical pronunciations for the child corpus, and the adult corpus' pronunciations are based on the annotated phonemes for each utterance. A suitable phoneme sequence alignment may employ the shortest path through the composed FST, the results of which are used in the mispronunciation detection experiments outlined below. The median phoneme boundary error for adult speech was approximately 1 ms, and for children's speech was 11 ms.

After developing the acoustic-to-PF mapping system, a multi-target DNN-based mispronunciation detection and feedback system is constructed. By training the mispronunciation detection system on phonological feature probabilities from the acoustic mapping system, phoneme-level correct/incorrect assignments and specific corrective phonological feedback is provided.

To construct the model input, frame-level PF predictions as determined by the system described above (“actual PFs”) are used, concatenated with the expected canonical feature values (“expected PFs”). This results in 44 features for the adult corpus and 48 for the child corpus. Expected PFs are constructed according to either the manual phoneme segmentation or the output of the forced alignment procedure.

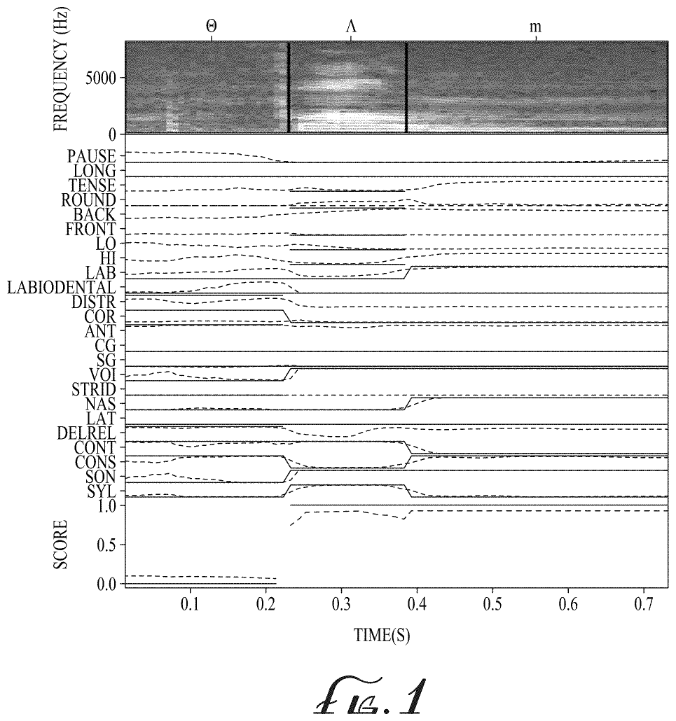

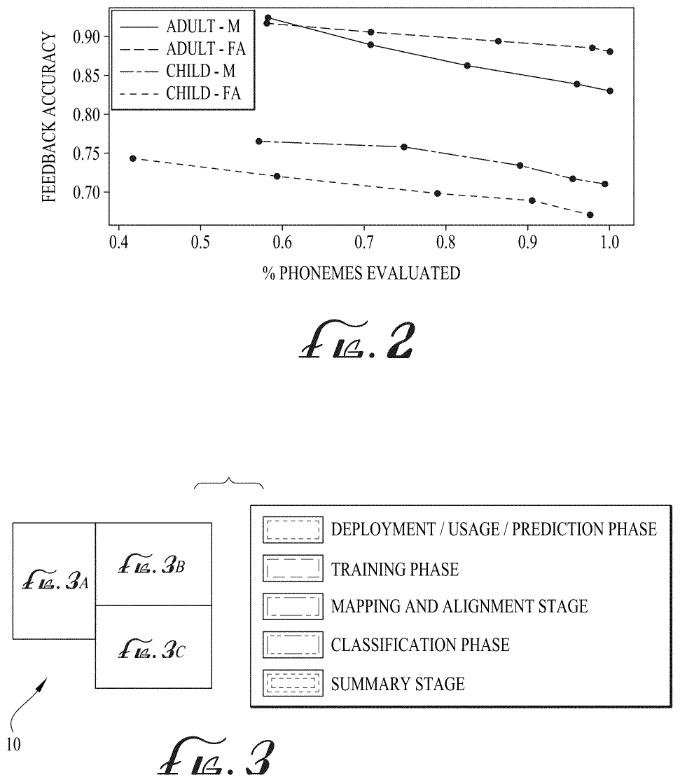

In some embodiments, a DNN classifier is employed for the mispronunciation detection system. For instance, an architecture with three dense layers with 32 neurons each, ReLU non-linearity, and a dropout rate of 0.2 may be used in some embodiments. Moreover, in some embodiments the network is split into two branches at its final layer: a first one for binary mispronunciation detection and a second one for multi-class targets corresponding to the phonological feature with the largest absolute error between the expected and actual PF values. This approach provides a level of confidence to deliver feedback (described later with reference to FIGS. 1 and 2).

Both corpora were comprised of approximately 90% correctly pronounced phonemes and only 10% mispronounced examples, with similar frame-level class ratios. To offset this class imbalance, the mispronunciation classification branch is trained using a weighted binary cross-entropy loss function. In addition, a weighted categorical cross-entropy loss function is used for the multi-class branch. The network is trained for up to 20 epochs, stopping early if the validation error increased for two sequential epochs, selecting the model state prior to the error increase. Speaker-independence is ensured by allowing no speaker overlap across train/validate/test sets.

To assess mispronunciation detection performance, a balanced accuracy (BAC, defined as the average of recall for each class) is calculated for all conditions at both frame and phoneme-level. To determine phoneme-level class label predictions, posterior probabilities are averaged over all associated frames. The system achieved 96% phoneme-level BAC on the adult mispronunciation corpus, exceeding accuracy rates reported for similar systems, although this high accuracy may be in part due to the relatively limited number of unique substitutions in the dataset (see Section under “Adults”). For the children's speech, system accuracy was reduced in comparison, unsurprising given the lower accuracy of the acoustic mapper used to generate the PF vectors. However, the results are on par with generally accepted criteria for human inter-rater percent agreement for perceptual judgment of speech (75-85%), a threshold often used in evaluating CAPT tools. As it is commonly accepted that false rejections are more detrimental to learners than false positives, and the false rejection rate (FRR) and false accuracy rate (FAR) are also calculated. These rates are roughly equivalent. Results for all conditions can be found in Table 2.

TABLE 2
Example Results of Mispronunciation Detection Experiments,
Comparing Manual (M) to Force Aligned Segmentation (FA)

| | Frame BAC | Phoneme BAC | FAR | FRR |
|---|---|---|---|---|
| Adult/M | 95% | 95% | 4% | 6% |
| Adult/FA | 96% | 96% | 2% | 5% |
| Child/M | 80% | 76% | 22% | 20% |
| Child/FA | 79% | 77% | 25% | 22% |

Phonological feedback entails identifying the most likely phonological feature error for feedback. A set of expected errors is first established for each substitution, including features which should be present for the expected phoneme but not for the actual phoneme, and vice versa. For example, FIG. 1 shows an overview of automatic segmentation, phonological feature identification, and mispronunciation predictions of the word thumb ([θAm]), mispronounced as [fAm]. Target features are shown in solid lines (where applicable) and predicted features are shown in broken lines. For the substitution [θ]→[f] in the example of FIG. 1, the expected set of feature errors are coronal ([θ]=1, [f]=0), labial ([θ]=0, [f]=1), and labiodental ([θ]=0, [f]=1). Moreover, with reference to FIG. 1, note that the set of expected feature errors (cor, lab, labiodental) are among the predicted features which deviate most from the target features.

For each phoneme correctly identified as mispronounced by the classifier, frame-level error probabilities (referred to as “confidence values”) output by the multi-class branch of the mispronunciation model are averaged. The feature with the highest confidence value is selected as the target for feedback. Using this method, phonemes for feedback are selectable based on a confidence threshold. By selecting a stricter threshold, feedback with higher confidence and accuracy (feedback was considered correct if the feature selected was in the set of expected errors) is provided, albeit for a smaller percentage of phonemes.

Accuracy of the disclosed method may be assessed using a range of threshold values. For example, FIG. 2 shows feedback accuracy results for all conditions, using confidence thresholds ranging from 0.5-0.1, from left to right. As the threshold is increased, feedback accuracy also increased, reaching as high as 91% for adult speech (with feedback provided for about 60% of phonemes considered) and 74-77% for children's speech (roughly 40-60% of phonemes). The least restrictive threshold assigned feedback to nearly all phonemes, with a decrease in accuracy of 5-10%.

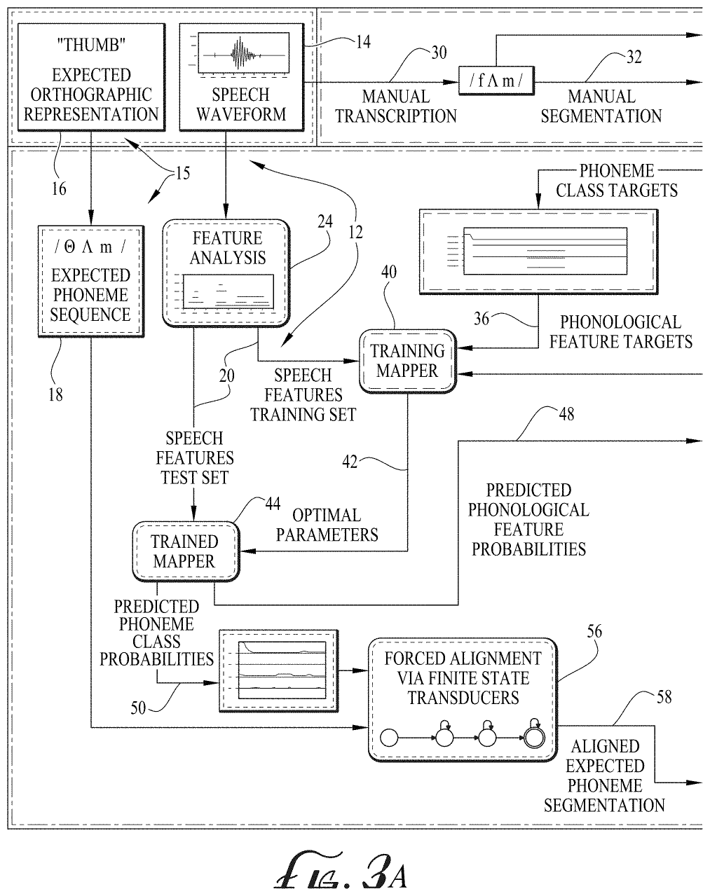

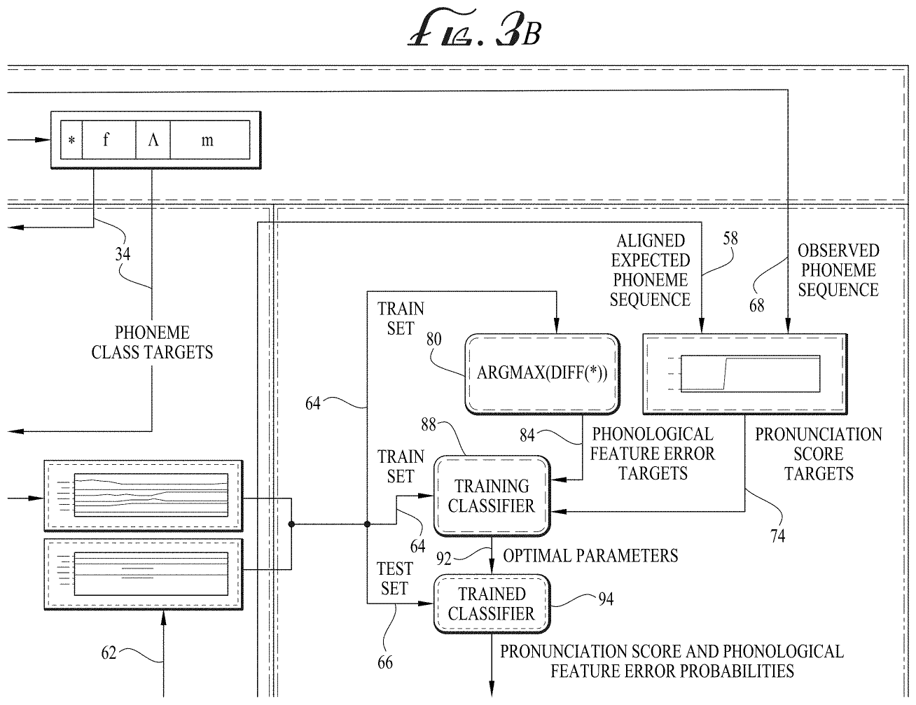

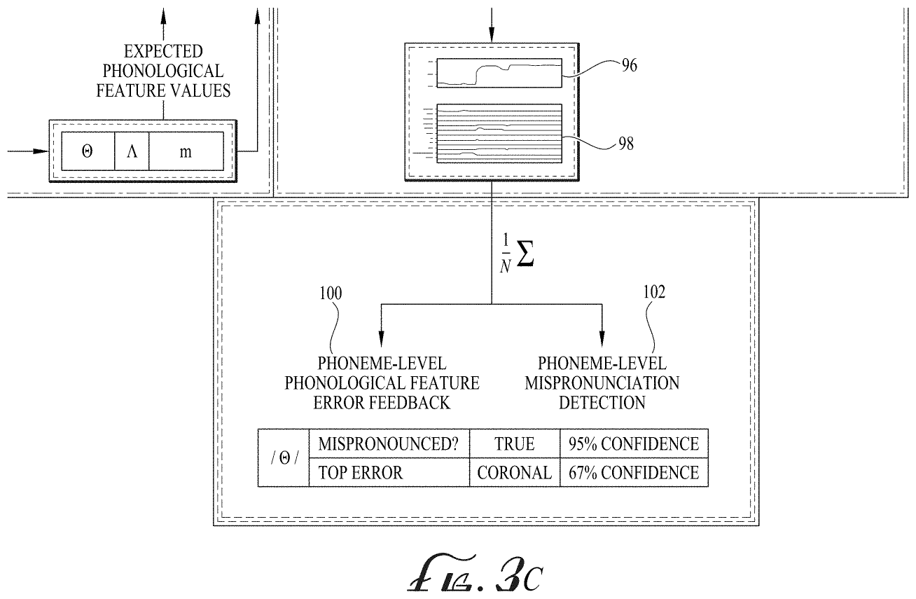

FIG. 3 shows that components and regions in a flow diagram 10 of FIGS. 3A, 3B, and 3C are encompassed by different broken line types so as to represent different phases or stages of the above-described techniques. For example, components that are shown encompassed by a first broken line type region represent features utilized during a deployment/usage/prediction phase. Components shown encompassed by a second broken line type region embody a training phase, recognizing that some deployment components are also employed during training, according to some embodiments. Components shown encompassed by a third broken line type region represent a mapping and alignment stage (i.e., processing stage one). Components shown encompassed by a fourth broken line type region represent a classification phase (i.e., processing stage two). And finally, components shown encompassed by a firth broken line type region represent a summary stage (i.e., processing stage three) to provide feedback that may be tailored to different applications having widespread applicability to speech training, clinical assessment tools, and other applications. Rounded boxes represent processes, while square boxes represent inputs, intermediate results, or outputs.

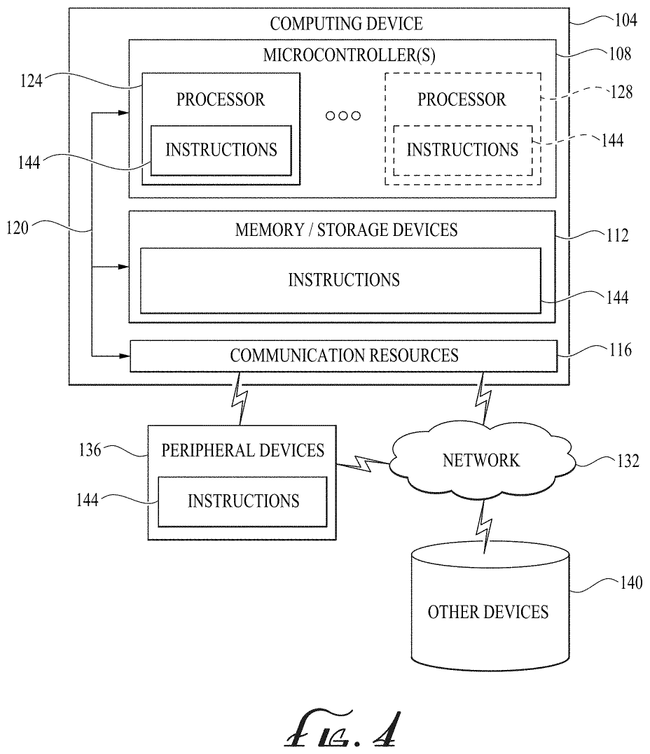

Various subcombinations of regions and boxes may be included in a computer-based pronunciation analysis and phonological feedback system, so skilled persons should appreciate that a particular system need not include every phase and stage. Likewise, a particular system need not be implemented as a common platform. For instance, the components of the deployment phase may be implemented as a software as a service (SaaS) model in which different servers and devices carry out separate aspects of the deployment phase. For example, stages one and two may be performed on remotely located systems separate from and communicatively coupled with a general-purpose computer acting as an input system collecting speech waveforms and expected linguistic content for stage one. Likewise, stages two and three may be distributed systems. Moreover, the phases and stages may be implemented in various forms including on servers, general-purpose computers, specialized hardware platforms including ASICs, or other devices. Additional examples of devices are provided later with reference to FIG. 4.

The example flow diagram 10 expands on the previous description of detecting mispronunciation of “thumb.” Accordingly, as a first system input, FIG. 3A shows a speech representation 12 of a sampled speech waveform 14 depicted as a time-varying waveform of the word “thumb” ([θAm]), mispronounced as “fumb” [fAm]. As a second system input, expected linguistic content 15 comprised of either an orthographic representation 16 (e.g. “thumb”), an expected phoneme sequence 18, or another data structure, is provided. A dictionary lookup may be performed to obtain expected phoneme sequence 18 from orthographic representation 16. In other embodiments, expected linguistic content 15 may include a text string previously decomposed into phoneme class sequence, and it may include other aspects such as which syllable is emphasized, which word is emphasized, expected prosody, including pitch and duration.

In some embodiments, speech representation 12 is sampled speech waveform 14 directly or any other speech representation derived from sample speech waveform 14. For example, in another embodiment, speech representation 12 includes speech features 20 output from an optional feature analysis component 24. An example of optional feature analysis component 24 is an analysis component that calculates mel-scale log filterbank values. Other types of speech features include mel-frequency cepstral coefficients, linear prediction coefficients, and other types. In yet other embodiments, such speech feature analysis is skipped and speech waveform 14 is provided as a direct input to the first processing stage.

During the training phase, sampled speech waveform 14 is also subjected to manual transcription 30 and manual phoneme segmentation 32. Examples of these processes are described previously. As shown in FIGS. 3A and 3B, manual phoneme segmentation 32 provides phoneme class targets 34 (FIG. 3B) for the training phase of stage one. Phoneme class targets 34 are converted to phonological feature targets 36 (FIG. 3A) by use of a look-up table or other conversion function. For example, each phoneme class target has a corresponding set of phonological feature targets that are either present (“1”), absent (“0”), or not applicable (“NaN”). In other embodiments, rather than using a discontinuous target trajectory, continuous target trajectories having values between zero and one may be used, derived from processes that simulate the physiology of articulators.

Speech representation 12 (e.g., speech features 20), phoneme class targets 34, and phonological feature targets 36 are applied as inputs for training a universal function approximator 40 (FIG. 3A) configured for mapping. An example of a universal function approximator in the machine learning context is a neural network, such as the CNN described previously. Other trainable models include Joint-Density Gaussian Mixture Models, Support Vector Machines for regression, or any suitable regression technique.

Once training is complete, trained model parameters 42, such as neural network weights or Gaussian priors, means, and covariances, are provided to a first trained universal function approximator 44. First trained universal function approximator 44 also receives speech representation 12 (e.g., speech features 20). It maps speech representation 12 to predicted phonological feature probabilities 48 and predicted phoneme class probabilities 50. As shown in FIG. 3A, probabilities 48 and 50 are visually represented by sets of plots of probabilities changing over time/frame for each feature and class. In practice, non-visual representations are contemplated.

Expected phoneme sequence 18 and predicted phoneme class probabilities 50 are applied as inputs to a forced alignment process 56 (e.g., by means of FSTs). Using expected phoneme sequence 18 and the predicted phoneme class probabilities 50, forced alignment process 56 generates an expected, automatic phoneme segmentation 58. As described above with reference to phonological feature targets 36, a look-up process converts automatic phoneme segmentation 58 to expected phonological feature values 62 (FIG. 3B), according to one embodiment. Predicted phonological feature probabilities 48 and expected phonological feature values 62 are then provided as inputs to processing stage two (i.e., classification). (For conciseness, the set of probabilities 48 and values 62 are referred to as, respectively, train set 64 and test set 66, each of which is a concatenation or other combination of probabilities 48 and values 62.)

During training of stage two, additional inputs include an observed phoneme sequence 68 (e.g., [fAm]) and an aligned expected phoneme sequence 58. Two sequences 68 and 58 are compared to generate pronunciation score targets 74. The timing information is sourced from the timing of aligned expected phoneme sequence 58. For example, the score of non-matching phonemes is set to zero whereas that of matching phonemes is set to one. Also, an argmax-diff process 80 receives train set 64 and finds the phonological feature with the largest difference between predicted phonological feature probabilities 48 and expected phonological feature values 62 to generate phonological feature error targets 84. For each point in time, argmax-diff process 80 finds the absolute difference between predicted phonological feature probabilities 48 and expected phonological feature values 62 and determines the specific phonological feature (e.g., coronal) having the largest difference value. This information is then converted to a one-hot vector, where the vector component set to one indicates the phonological feature with the largest difference.

Train set 64, pronunciation score targets 74, and phonological feature error targets 84 are applied as inputs for training a universal function approximator 88 configured for classifying. An example of a universal function approximator in the machine learning context is a neural network, such as the DNN described previously. Other trainable models include Gaussian Mixture Models, Support Vector Machines, or any other trainable model suitable for classification.

Once training is complete, trained model parameters 92 are provided to a second trained universal function approximator 94. Examples of trained model parameters 92 include neural network weights, or Gaussian priors, means, and covariances. Second trained universal function approximator 94 receives test set 66 (i.e., a combination of the predicted phonological feature probabilities and the expected phonological feature values) and classifies test set 66 to thereby detect a mispronunciation present in sampled speech waveform 14 and facilitate phonological feature feedback associated with the mispronunciation.

In some embodiments. second trained universal function approximator 94 generates a pronunciation score 96 that varies over each frame (e.g., to assess errors at a phoneme- or even sub-phoneme-level). In some embodiments, second trained universal function approximator 94 generates phonological feature error probabilities 98 that vary over each frame (e.g., to assess errors at a phoneme- or even sub-phoneme-level).

Error feedback based on one or both score 96 and probabilities 98 (FIG. 3B) can be provided in various different forms in processing stage three. An example shown in FIG. 3C shows phoneme-level phonological error feedback 100 and phoneme-level mispronunciation detection feedback 102 in the form of a table. The table sets forth the phoneme that was mispronounced, a confidence calculation for that mispronunciation assessment, a leading phonological error attributable to that mispronunciation, and a confidence calculation for that leading phonological error assessment. Such reporting may be withheld if the confidence is below a threshold. In other embodiments, additional leading errors may be reported (in addition to a top error). Confidence values are calculated by a simple linear transformation of raw scores. For example, the mispronunciation confidence score is 0% when the pronunciation score probability 102 is 0.5, the former is 100% when the latter is either 0 (definitely mispronounced) or 1 (definitely correctly pronounced). An example approach for determining a confidence score for prominent phonological error feedback 100 is using the maximum (over features at one point in time) raw score of phonological feature error probabilities 98. Confidence scores can be averaged over phonemes to derive phoneme-level confidences. Other statistics may be suitable as well, depending on the application. Sensitivity to including or excluding results in application reporting can be changed by adjusting a threshold against which the confidence scores are compared. Changing sensitivity allows the application to improve accuracy at the cost of being unable to make a determination for some parts of the input.

Embodiments described herein may be implemented in any suitably configured hardware and software resources of computing device 104, as shown in FIG. 4. And various aspects of certain embodiments are implemented using hardware, software, firmware, or a combination thereof, for reading instructions from a machine- or computer-readable non-transitory storage medium and thereby performing one or more of the methods realizing the disclosed algorithms and techniques. Specifically, computing device 104 can include one or more microcontrollers 108, one or more memory/storage devices 112, and one or more communication resources 116, all of which are communicatively coupled via a bus or other circuitry 120.

For example, in some embodiments, computing device 104 is a computer configured to train a CNN-based mapper or a DNN-based mispronunciation system. In another embodiment, computing device 104 is a computer configured to analyze acoustic data in one or both of a trained CNN-based mapper and a trained DNN-based mispronunciation system. For example, computing device 104 includes a laptop executing a software application to analyze the acoustic data.

In another embodiment, computing device 104 includes a server to receive and process the data in a cloud-based or software-as-a-service (SaaS) embodiment. In other words, receiving data occurs via a network 132. For example, acoustic data or audio files may be received from another device 140 via network 132. Alternatively, in other embodiments the receiving occurs directly, without use of network 132, from a peripheral device 136. The direct reception may occur via wired communication (e.g., for communication via a Universal Serial Bus (USB)), Near Field Communication (NFC), Bluetooth® (e.g., Bluetooth® Low Energy), or other forms of wireless communication, for example.

In some embodiments, the acoustic data is received from other device 140 via both network 132 and peripheral device 136. In some embodiments, the acoustic data is received from peripheral device 136 via network 132.

In some embodiments, microcontroller(s) 108, includes, for example, one or more processors 124 (shared, dedicated, or group), one or more optional processors (or additional processor core) 128, one or more ASIC or other controller to execute one or more software or firmware programs, one or more combinational logic circuit, or other suitable components that provide the described functionality.

In some embodiments, memory/storage devices 112 includes main memory, cache, flash storage, or any suitable combination thereof. A memory device 112 may also include any combination of various levels of non-transitory machine-readable memory including, but not limited to, electrically erasable programmable read-only memory (EEPROM) having embedded software instructions (e.g., firmware), dynamic random-access memory (e.g., DRAM), cache, buffers, or other memory devices. In some embodiments, memory is shared among the various processors or dedicated to particular processors.

In some embodiments, communication resources 116 include physical and network interface components or other suitable devices to communicate with one or more peripheral devices 136. In one example, communication resources 116 communicates via a network 132 with one or more peripheral devices 136 (e.g., computing devices, imaging devices, etc.) or one or more other devices 140 (e.g., other computing devices, other imaging devices). In some embodiments, network 132 uses one or more of a wired communication (e.g., for communication via a Universal Serial Bus (USB)), cellular communication, Near Field Communication (NFC), Bluetooth® (e.g., Bluetooth® Low Energy), Wi-Fi®, and any other type of wired or wireless communication. In some embodiments, communication resources 116 includes one or more of wired communication components (e.g., for coupling via a Universal Serial Bus (USB)), cellular communication components, Near Field Communication (NFC) components, Bluetooth® components (e.g., Bluetooth® Low Energy), Wi-Fi® components, and components for any other type of wired or wireless communication.

In some embodiments, instructions 144 comprises software, a program, an application, an applet, an app, or other executable code for causing at least any of microcontroller(s) 108 to perform any one or more of the methods discussed herein. For example, instructions 144 can facilitate receiving (e.g., via communication resources 116) acoustic data discussed previously. Instructions 144 can then facilitate the processing described in accordance with the embodiments of this disclosure.

In some embodiments, instructions 144 reside completely or partially within one (or more) of microcontroller(s) 108 (e.g., within a processor's cache memory), memory/storage devices 112, or any suitable combination thereof. Furthermore, any portion of instructions 144 may be transferred to computing device 104 from any combination of peripheral devices 136 or the other devices 140. Accordingly, memory of microcontroller(s) 108, memory/storage devices 112, peripheral devices 136, and the other devices 140 are examples of computer-readable and machine-readable media.

In some embodiments, instructions 144 also, for instance, comprise one or more physical or logical blocks of computer instructions, which may be organized as a routine, program, object, component, data structure, text file, or other instruction set facilitating one or more tasks or implementing particular data structures or software modules. A software module, component, or library may include any type of computer instruction or computer-executable code located within or on a non-transitory computer-readable storage medium. In certain embodiments, a particular software module, component, or programmable rule comprises disparate instructions stored in different locations of a computer-readable storage medium, which together implement the described functionality. Indeed, a software module, component, or programmable rule may comprise a single instruction or many instructions, and may be distributed over several different code segments, among different programs, and across several computer-readable storage media. Some embodiments can be practiced in a distributed computing environment where tasks are performed by a remote processing device linked through a communications network.

In some embodiments, instructions 144, for example, include .Net and C libraries providing machine-readable instructions that, when executed by processor 124, cause processor 124 to perform analysis techniques in accordance with the present disclosure, including detecting a mispronunciation.

In some embodiments, acoustic data used in techniques of the present disclosure are received by computing device 104 from one or more other devices 140, one or more peripheral devices 136, or a combination of one or more other devices 140 and peripheral devices 136. In some embodiments, one or both of other devices 140 and peripheral devices 136 are recording devices or any other kind of audio or video device that capture the acoustic data, video data, or both. In some embodiments, one or both of other devices 140 and peripheral devices 136 are computing devices that store such data.

Some embodiments integrate mispronunciation detection and feedback functionality into a graphical application that can be used for screening, assistance with diagnosis, and training purposes.

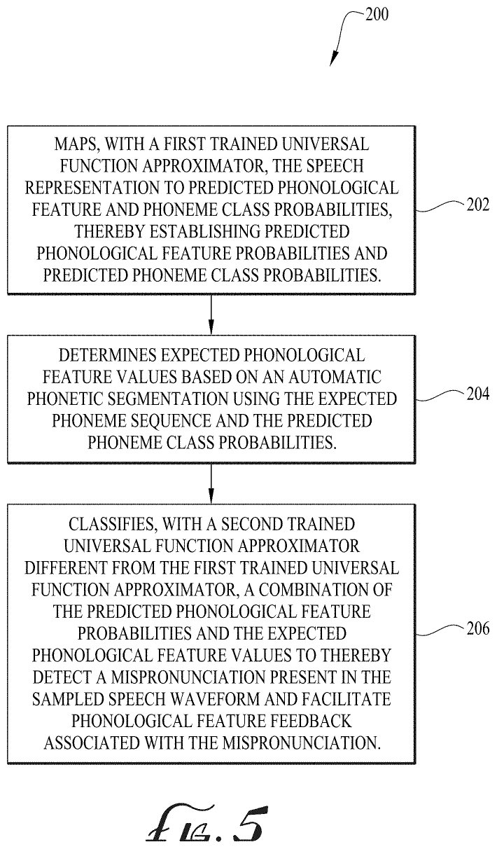

FIG. 5 shows a routine 200, performed by a computer-based pronunciation analysis system, of detecting phoneme mispronunciation and facilitating phonological feature feedback based on a speech representation of a sampled speech waveform and expected linguistic content, the expected linguistic content including an expected phoneme sequence. In block 202, routine 200 maps, with a first trained universal function approximator, the speech representation to predicted phonological feature and phoneme class probabilities, thereby establishing predicted phonological feature probabilities and predicted phoneme class probabilities. In block 204, routine 200 determines expected phonological feature values based on an automatic phonetic segmentation using the expected phoneme sequence and the predicted phoneme class probabilities. In block 206, routine 200 classifies, with a second trained universal function approximator different from the first trained universal function approximator, a combination of the predicted phonological feature probabilities and the expected phonological feature values to thereby detect a mispronunciation present in the sampled speech waveform and facilitate phonological feature feedback associated with the mispronunciation.

Routine 200 may also include the speech representation as a time-varying speech waveform, such that routine 200 further includes to process the time-varying speech waveform with a filterbank to generate the speech representation in a form of speech features. In some embodiments, the processing of the time-varying speech waveform includes analyzing it with a mel-scale log filterbank.

In some embodiments, the speech representation includes multiple frames and the predicted phonological feature probabilities include, for each frame, a set of probability values for each predicted phonological feature.

In some embodiments, the speech representation includes multiple frames and the predicted phoneme class probabilities include, for each frame, a set of probability values for each predicted phoneme class.

In some embodiments, the determining of routine 200 includes generating the automatic phonetic segmentation by temporally locating each phoneme of the expected phoneme sequence based on the predicted phoneme class probabilities. In some embodiments, the temporally locating includes processing the expected phoneme sequence and the predicted phoneme class probabilities with a finite state transducer.

In some embodiments, the determining of routine 200 includes converting the automatic phonetic segmentation to the expected phonological feature values based on a preconfigured model.

In some embodiments, the speech representation includes multiple frames and routine 200 further includes providing frame-level phonological feature feedback associated with the mispronunciation.

In some embodiments, the classifying of routine 200 includes adjusting sensitivity of mispronunciation detection based on a threshold applied to an output of the second trained universal function approximator.

In some embodiments, routine 200 includes calculating a confidence score for the mispronunciation.

In some embodiments, the phonological feature feedback includes a confidence score for a phonological feature error.

In some embodiments, routine 200 further includes training one or both of the first and second trained universal function approximator. In some embodiments, the first trained universal function approximator includes a convolutional neural network. In some embodiments, the second trained universal function approximator includes a deep neural network.

Other technical features may be readily apparent to one skilled in the art from the following figures, descriptions, and claims. Skilled persons will appreciate that many changes may be made to the details of the above-described embodiments without departing from the underlying principles of the invention. The scope of the present invention should, therefore, be determined only by the following claims.

1. A method, performed by a computer-based pronunciation analysis system, of detecting phoneme mispronunciation and facilitating phonological feature feedback based on a speech representation of a sampled speech waveform and expected linguistic content, the expected linguistic content including an expected phoneme sequence, the method comprising:
mapping, with a first trained universal function approximator, the speech representation to predicted phonological feature and phoneme class probabilities, thereby establishing predicted phonological feature probabilities and predicted phoneme class probabilities;
determining expected phonological feature values based on an automatic phonetic segmentation using the expected phoneme sequence and the predicted phoneme class probabilities; and
classifying, with a second trained universal function approximator different from the first trained universal function approximator, a combination of the predicted phonological feature probabilities and the expected phonological feature values to thereby detect a mispronunciation present in the sampled speech waveform and facilitate phonological feature feedback associated with the mispronunciation.

2. The method of claim 1, in which the speech representation is a time-varying speech waveform, the method further comprising processing the time-varying speech waveform with a filterbank to generate the speech representation in a form of speech features.

3. The method of claim 2, in which the processing of the time-varying speech waveform includes analyzing it with a mel-scale log filterbank.

4. The method of claim 1, in which the speech representation includes multiple frames and the predicted phonological feature probabilities include, for each frame, a set of probability values for each predicted phonological feature.

5. The method of claim 1, in which the speech representation includes multiple frames and the predicted phoneme class probabilities include, for each frame, a set of probability values for each predicted phoneme class.

6. The method of claim 1, in which the determining comprises generating the automatic phonetic segmentation by temporally locating each phoneme of the expected phoneme sequence based on the predicted phoneme class probabilities.

7. The method of claim 6, in which the temporally locating comprises processing the expected phoneme sequence and the predicted phoneme class probabilities with a finite state transducer.

8. The method of claim 1, in which the determining comprises converting the automatic phonetic segmentation to the expected phonological feature values based on a preconfigured model.

9. The method of claim 1, in which the speech representation includes multiple frames and the method further comprises providing frame-level phonological feature feedback associated with the mispronunciation.

10. The method of claim 1, in which the classifying comprises adjusting sensitivity of mispronunciation detection based on a threshold applied to an output of the second trained universal function approximator.

11. The method of claim 1, further comprising calculating a confidence score for the mispronunciation.

12. The method of claim 1, in which the phonological feature feedback comprises a confidence score for a phonological feature error.

13. The method of claim 1, further comprising training one or both of the first and second trained universal function approximator.

14. The method of claim 1, in which the first trained universal function approximator comprises a convolutional neural network.

15. The method of claim 1, in which the second trained universal function approximator comprises a deep neural network.

16. One or more non-transitory computer-readable storage devices storing instructions thereon that, when executed by one or more processors implementing a computer-based pronunciation analysis system configured to detect phoneme mispronunciation and provide phonological feature feedback based on a speech representation of a sampled speech waveform and expected linguistic content that includes an expected phoneme sequence, configure the one or more processors to perform the method of claim 1.
